(19) United States
(12) Patent Application Publication
(10) Pub. No.: US 2011/0256447 A1
(43) Pub. Date: Oct. 20, 2011

(54) BATTERY

(75) Inventor: LUNG DAI, Tu-Cheng (TW)

(73) Assignee: HON HAI PRECISION INDUSTRY CO., LTD., Tu-Cheng (TW)

(21) Appl. No.: 12/868,172

(22) Filed: Aug. 25, 2010

(30) Foreign Application Priority Data
Apr. 19, 2010 (TW) 99112106

(51) Int. Cl. H01M 2/08

(52) U.S. Cl. 429/174

(57) ABSTRACT

A battery includes an insulating body, a brass cap, a cathode plate, and a protection member. The brass cap is disposed on one end of the insulating body as an anode of the battery. The cathode plate is disposed on the other end of the insulating body as a cathode of the battery. The protection member is disposed on a joint between the cathode plate and the insulating body for sealing thereof.

### BACKGROUND

1. Technical Field

The present disclosure relates to batteries, and particularly to a dry cell battery.

2. Description of Related Art

When a battery is set aside for some time, the chemical mixture, which is stored in a zinc can of the battery, may leak out of the battery.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiment of a battery. Moreover, in the drawings, like reference numerals designate corresponding parts throughout two views.

FIG. 1 is an isometric, schematic view of a battery according to an exemplary embodiment.

FIG. 2 is a cross-sectional view of the battery of FIG. 1.

### DETAILED DESCRIPTION

Embodiments of the present disclosure will now be described in detail with reference to the drawings.

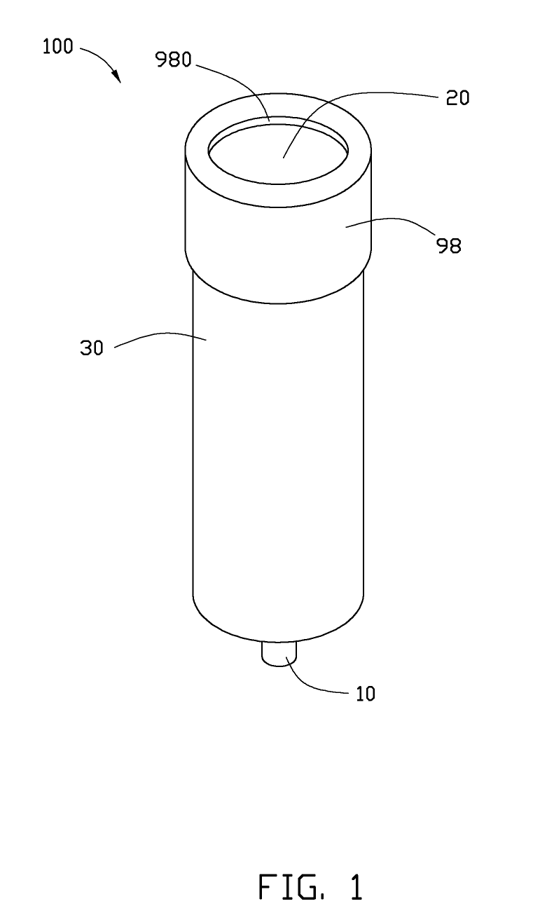

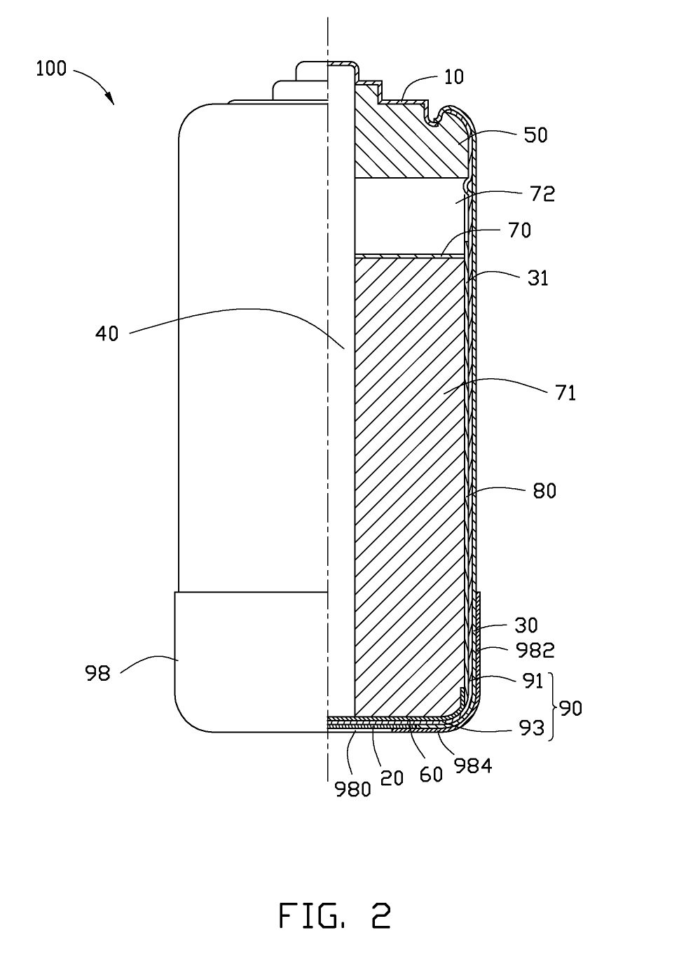

Referring to FIGS. 1 and 2, a battery 100 according to an exemplary embodiment is illustrated. The battery 100 includes a brass cap 10, a cathode plate 20, an insulating body 30, a carbon rod 40, a plastic seal 50, a fixing member 60, a blocking member 70, a chemical mixture 71, a porous film 80, a zinc can 90, and a protection member 98.

The insulating body 30 is substantially cylindrical and defines a chamber 31. The chamber 31 is for receiving the cathode plate 20, the carbon rod 40, the plastic seal 50, the fixing member 60, the blocking member 70, the chemical mixture 71, the porous film 80, and the zinc can 90. In this embodiment, the insulating body 30 is a label. The label is usually used as a decoration.

The zinc can 90 is attached to the inside of the insulating body 30, and one end of the zinc can 90 is sealed. The zinc can 90 includes a side wall 91 and a bottom 93. The bottom 93 is connected to one end of the side wall 91.

The porous film 80 is attached to the side wall 91 of the zinc can 90. Thus, the zinc can 90 is sandwiched between the insulating body 30 and the porous film 80. The porous film 80 is permeable.

The brass cap 10 is substantially cylindrical. The brass cap 10 seals one end of the insulating body 30 and is electrically connected to the side wall 91 of the zinc can 90 to define an anode of the battery 100.

The plastic seal 50 and the fixing member 60 are received in the chamber 31. The plastic seal 50 is disposed under the brass cap 10 and seals the zinc can 90. The fixing member 60 faces the plastic seal 50 and is disposed above the bottom 93 of the zinc can 90.

The blocking member 70 is received in the chamber 31 and is disposed between the plastic seal 50 and the fixing member 60. The blocking member 70 is made of insulating a material. The blocking member 70, the zinc can 90, and the plastic seal 50 cooperatively define an expansion space 72 for the chemical mixture 71.

The chemical mixture 71 is received in the chamber 31 and is under the blocking member 70. The range of the chemical mixture 71 is limited by the blocking member 70. The chemical mixture 71 has a chemical reaction within the zinc can 90 by permeating the porous film 80.

One end of the carbon rod 40 is electrically connected to the brass cap 10 to define the brass cap 10 as the anode of the battery 100. The other end of the carbon rod 40 stands on the center of the fixing member 60 after passing through the plastic seal 50, the blocking member 70, and the chemical mixture 71.

The cathode plate 20 is received in the chamber 31 and seals one end of the insulating body 30. The cathode plate 20 is positioned under the bottom 93 of the zinc can 90. The cathode plate 20 is electrically connected to the bottom 93 to define a cathode of the battery 100.

The protection member 98 encases the cathode of the battery 100. The protection member 98 is used for preventing the cathode of the battery 100 from leakage. The protection member 98 seals the joint between the cathode plate 20 and the insulating body 30. The protection member 98 defines an opening 980 to expose part of the cathode plate 20. The cathode plate 20 is electrically connected to an electronic device (not shown) by passing through the opening 980.

In this embodiment, the protection member 98 includes a hollow column 982 and a connecting board 984 extending from the hollow column 982. The hollow column 982 sleeves the insulating body 30, and the connecting board 984 coves one end of the insulating body 30 on which the cathode plate 20 is disposed. The hollow column 982 is configured for enforcing the connection between the insulating body 30 and the connecting board 984. The connecting board 984 is configured for sealing the joint between the cathode plate 20 and the insulating body 30. The opening 980 is defined in the connecting board 984.

As the joint between the cathode plate 20 and the insulating body 30 is sealed by the connecting board 984 of the protection member 98, the chemical mixture 71 in the battery 10 can be prevented from leakage. As the cathode plate 20 can be electrically connected with the electronic device by a connection on the opening 980, the protection member 98 will not affect the utility of the battery 100.

The connecting board 984 of the protection member 98 can be made of metal or insulating material. When the connecting board 984 is made of metal, a protective film will be formed by a chemical reaction after the battery 100 leaks. Thus, the protection film can help the connecting board 984 to further prevent the chemical mixture 71 in the battery 10 from leakage.

In other embodiments, the opening 980 can be removed, and the connecting board 984 covers the cathode plate 20 of the battery 100 and is electrically connected to the cathode plate 20 to act as the cathode of the battery 100.

In other embodiments, the hollow column 982 can be removed, and the connecting board 984 is fixed on the cathode plate 20 of the cathode of the battery 100 to seal the joint between the cathode plate 20 and the insulating body 30.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A battery, comprising:
an insulating body;
a brass cap disposed on one end of the insulating body acting as an anode of the battery;
a cathode plate disposed on the other end of the insulating body acting as a cathode of the battery;
a protection member disposed on a joint between the cathode plate and the insulating body for sealing thereof.

2. The battery of claim 1, wherein the protection member defines an opening to expose part of the cathode plate.

3. The battery of claim 2, wherein the protection member comprises a connecting board disposed on the other end of the insulating body to seal the joint between the cathode plate and the insulating body, and the opening is defined on the connecting board.

4. The battery of claim 3, wherein the protection member further comprises a hollow column, the connecting board is connected to one end of the hollow column, the hollow column sleeves on the insulating body.

5. The battery of claim 4, wherein the connecting board extends from the hollow column to be as one body with the hollow column.

6. The battery of claim 1, wherein the protection member comprises a connecting board is disposed on the other end of the insulating body to seal the joint between the cathode plate and the insulating body, and the connecting board is electrically connected to the cathode plate to act as the cathode of the battery.

7. The battery of claim 6, wherein the protection member further comprises a hollow column, the connecting board is connected to one end of the hollow column, and the hollow column sleeves on the insulating body.

8. The battery of claim 2, wherein the protection member is made of insulating material.

9. The battery of claim 2, wherein the protection member is made of metal.
